(19) United States
(12) Patent Application Publication
(10) Pub. No.: US 2010/0303702 A1
(43) Pub. Date: Dec. 2, 2010

(54) METHOD OF PRODUCING POWDER, POWDER, AND ADSORPTION APPARATUS

(75) Inventor: Yoshiyuki OGAWARA, Tochigi (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/791,115

(22) Filed: Jun. 1, 2010

(30) Foreign Application Priority Data
Jun. 2, 2009 (JP) 2009-133531
Jun. 2, 2009 (JP) 2009-133532

(51) Int. Cl. C01B 25/32; B29B 9/16; B01J 20/04

(52) U.S. Cl. 423/308; 264/9; 428/402

(57) ABSTRACT

A method of producing powder by using a first liquid and a second liquid to be mixed with the first liquid, the first liquid containing a first raw material and the second liquid containing a second raw material. The method comprises: mixing the first liquid and the second liquid to obtain a mixture; stirring the mixture for reacting the first raw material and the second raw material to thereby obtain a synthetic material and a slurry containing aggregates of the synthetic material; and drying the slurry to obtain powder of the synthetic material. In the mixing the first liquid and the second liquid, particle strength of the powder is adjusted by setting an initial temperature of mixing the first liquid with the second liquid.

### FIELD OF THE INVENTION

The present invention relates to a method of producing powder, powder and an adsorption apparatus, and in particular relates to a method of producing powder, powder obtained by the method and an adsorption apparatus that uses the powder.

There is well known a calcium phosphate-based compound which is a kind of ceramic material. Such a calcium phosphate-based compound has been generally used as a biomaterial and a material used for a stationary phase of a chromatography.

In the case where the calcium phosphate-based compound is used as a biomaterial, the calcium phosphate-based compound is treated as follows: a slurry containing the calcium phosphate-based compound is prepared to obtain powder of the calcium phosphate-based compound, the obtained powder is molded in a predetermined shape to obtain a green body, and then the green body is sintered to obtain a sintered body of the calcium phosphate-based compound. Such a sintered body has been used as an artificial bone, an artificial tooth root and the like in a clinical field.

On the other hand, in the case where the calcium phosphate-based compound is used as a material used for the stationary phase of the chromatography, the calcium phosphate-based compound is treated as follows: a slurry containing the calcium phosphate-based compound is prepared to obtain powder of the calcium phosphate-based compound, and then the powder is sintered to obtain sintered powder of the calcium phosphate-based compound. Such sintered powder is used by filling it into a column and the like (JP-A 2002-137910 is one example of the related arts).

However, in the sintered body used as the artificial bone, the artificial tooth root and the like, if particles of the powder produced in the middle of a producing process thereof do not have sufficient and uniform strength, there is a problem in that it is difficult to process the produced powder and control porosity of the produced powder. Therefore, in the case where the sintered body is produced, the following steps I to III are performed normally.

The step I is a step that the obtained powder is pre-baked to obtain pre-baked powder and thereafter the pre-baked powder is pulverized by a pulverizer (crasher). The step II is a step that the pulverized powder is mixed with a methylcellulose solution and the like to obtain a mixture. The step III is a step that the mixture is gelatinized and solidified to make a block of the mixture.

However, in the step I, if strength of particles of the powder is ununiform among the particles, conditions of pulverizing the pre-baked powder (e.g. a grain size distribution of the particles of the powder and the like after pulverizing) are likely to become ununiform. Therefore, there is a problem in that porosity and strength of the particles of the obtained sintered body become ununiform.

Furthermore, in the sintered powder used as the stationary phase of the chromatography, if particles of the powder before sintering do not have sufficient and uniform strength, the sintered powder is likely to be destroyed during a process of filling it into the column. This causes clogging of a filter of the column. As a result, there is a problem in that it is difficult to efficiently separate proteins by the chromatography.

### SUMMARY OF THE INVENTION

It is an object of the present invention to provide a method of producing powder that is capable of adjusting particle strength of the powder so that the obtained particles have sufficient and uniform strength. Furthermore, it is another object of the present invention to provide powder produced by using such a method of producing the powder and an adsorption apparatus that uses such powder.

These objects are achieved by the present inventions which are described below by the items (1) to (17).

(1) A method of producing powder by using a first liquid and a second liquid to be mixed with the first liquid is provided. The first liquid contains a first raw material and the second liquid containing a second raw material. The method comprises: mixing the first liquid and the second liquid to obtain a mixture; stirring the mixture for reacting the first raw material and the second raw material to thereby obtain a synthetic material and a slurry containing aggregates of the synthetic material; and drying the slurry to obtain powder of the synthetic material. In the mixing the first liquid and the second liquid particle strength of the powder is adjusted by setting an initial temperature of mixing the first liquid with the second liquid.

According to the method described above, it is possible to adjust particle strength of the powder so that the obtained particles have sufficient and uniform strength.

(2) In the method described in the above-mentioned item (1), the method further comprises: stirring the slurry between the stirring the mixture and the drying the slurry. In the stirring the slurry, the particle strength of the powder is adjusted by setting conditions of stirring the slurry.

According to the method described above, it is possible to adjust particle strength of the obtained powder so that the obtained particles have sufficient and uniform strength.

(3) In the method described in the above-mentioned item (1), the second liquid is dropped into the first liquid in the mixing the first liquid and the second liquid to thereby react the first raw material with the second raw material, wherein the initial temperature of mixing the first liquid with second liquid is set by setting an initial temperature of the first liquid.

According to the method described above, it is possible to reliably set an initial temperature to mix the first liquid with the second liquid.

(4) In the method described in the above-mentioned item (3), the initial temperature of the first liquid is set in the range of 0 to 20° C.

According to the method described above, it is possible to reliably improve a bulk density of powder obtained in the drying step.

(5) In the method described in the above-mentioned item (3), a temperature of the mixture of the first liquid and the second liquid is gradually increased when the second liquid is dropped into the first liquid.

According to the method described above, by synthesizing the synthetic material in the mixture under such conditions, it is possible to reliably improve a bulk density of powder obtained in the drying step.

(6) In the method described in the above-mentioned item (3), when the second liquid is dropped into the first liquid, an ambient temperature is normal temperature.

According to the method described above, it is possible to gradually increase a temperature of the mixture of the first and second liquids.

(7) In the method described in the above-mentioned item (6), when the slurry is obtained by reacting the first raw material with the second raw material, a temperature of the slurry is in the range of 30 to 50° C.

According to the method described above, it is possible to reliably improve a bulk density of powder obtained in the drying step.

(8) In the method described in the above-mentioned item (2), in the stirring the slurry containing the aggregates a stirring power of the slurry is in the range of 0.75 to 2.0 W with respect to 1 L of the slurry.

According to the method described above, it is possible to reliably obtain a small particle size of the first and second aggregates in the slurry and a larger abundance ratio of the first aggregates than that of the second aggregates.

(9) In the method described in the above-mentioned item (2), in the stirring the slurry containing the aggregates, a time of stirring the slurry is in the range of 3 to 10 days.

According to the method described above, it is possible to reliably obtain a small particle size of the first and second aggregates in the slurry and a larger abundance ratio of the first aggregates than that of the second aggregates.

(10) In the method described in the above-mentioned item (1), the synthetic material includes a ceramic material.

(11) In the method described in the above-mentioned item (1), the synthetic material includes a calcium phosphate-based compound.

(12) In the method described in the above-mentioned item (1), the first raw material is calcium hydroxide, the second raw material is phosphoric acid and the synthetic material is hyrdoxyapatite.

The present invention is suitable for a method of producing a ceramic material, in particular, powder of hydroxyapatite which is a kind of calcium phosphate-based compound.

(13) Powder is produced by using the method of producing the powder defined in the above-mentioned item (1).

According to the method described above, it is possible to obtain powder having superior particle strength.

(14) Powder is constituted of hydroxyapatite as a main component thereof. The powder is obtained by drying a slurry containing aggregates of the hydroxyapatite and granulating the aggregates. The powder is sintered to obtain sintered powder including sintered particles, and then the sintered particles are classified so that an average particle size thereof falls within 40±5 μm. When a compression particle strength of the classified sintered powder is measured, the compression particle strength is 1.0 MPa or more.

According to the powder having such compression particle strength described above, it is possible to exhibit superior particle strength.

(15) In the powder described in the above-mentioned item (14), the compression particle strength is 2.0 MPa or more.

According to the powder having such compression particle strength described above, it is also possible to exhibit superior particle strength.

(16) In the powder described in the above-mentioned item (14), the compression particle strength is 4.5 MPa or more.

According to the powder having such compression particle strength described above, it is also possible to exhibit superior particle strength.

(17) An adsorption apparatus is provided with the sintered powder obtained by sintering the powder described in the above-mentioned item (13) or the powder described in the above-mentioned item (14) as an adsorbent.

According to the adsorption apparatus described above, since particles of the powder used for the adsorbent has superior particle strength, it is possible to reliably use the adsorbent as an adsorbent for a separation column having large size.

According to the present invention, the first liquid containing the first raw material is mixed with the second liquid containing the second raw material to obtain a mixture, and then the first raw material is reacted with the second raw material while stirring the mixture to obtain a slurry containing a synthetic material such as a calcium phosphate-based compound. In such a process, by setting the initial temperature to mix the first liquid with the second liquid, it is possible to adjust particle strength of obtained powder so that the obtained particles have sufficient and uniform strength.

### BRIEF DESCRIPTION OF THE DRAWINGS

FIG. 1 is a view showing a ratio distribution curve of a grain size distribution of aggregates constituted of hydroxyapatite contained in a slurry.

FIG. 2 is a view showing a temperature change during dropping a phosphoric acid aqueous solution into a calcium hydroxide dispersion liquid.

FIG. 3 is a view showing a pH change during dropping a phosphoric acid aqueous solution into a calcium hydroxide dispersion liquid.

FIG. 4 is a view showing a frequency distribution curve of a grain size distribution of aggregates of hydroxyapatite contained in a slurry.

### BEST MODE FOR CARRYING OUT THE INVENTION

Hereinbelow, a method of producing powder, powder and an adsorption apparatus according to the present invention will be described in detail with reference to their preferred embodiments.

First, a description will be made on a method of producing powder according to the present invention.

The method of producing the powder according to the present invention includes a first step and a second step. The first step is a step that a first liquid containing a first raw material are mixed with a second liquid containing a second raw material to obtain a mixture, and then the first raw material is reacted with the second raw material while stirring the mixture to obtain a synthetic material and a slurry containing aggregates of the synthetic material. The second step is a step that the slurry is dried to obtain powder of the synthetic material.

Furthermore, the method of producing the powder according to the present invention may include a sub-step between the first and second steps. The sub-step is a step that the obtained slurry containing the aggregates is stirred.

Here, the powder includes a powder-particle body, a granulated powder and the like. The shape and embodiment of the powder are particularly not limited to specific shape and embodiment.

The synthetic material according to the present invention may be any one of an organic material and an inorganic material, but preferably the inorganic material including a ceramic material and more preferably the ceramic material.

Examples of the ceramic material include: oxide-based ceramics such as alumina, silica, titania, zirconia, yttria and the like; a calcium phosphate-based compound; nitride-based ceramics such as silicon nitride, aluminium nitride, titanium nitride, boron nitride and the like; a ferroelectric material such as barium titanate, strontium titanate, PZT, PLZT, PLLZT and the like.

Here, the calcium phosphate-based compound has been used as a biomaterial and a material used for a stationary phase of a chromatography. Examples of the calcium phosphate-based compound include apatites such as hydroxyapatite, fluoroapatite, carbonate apatite and the like; dicalcium phosphate; tricalcium phosphate; tetracalcium phosphate; octacalcium phosphate; and the like.

Among the compounds, hydroxyapatite has high biocompatibility. Therefore, hydroxyapatite is used for the biomaterial, in particular, a filler for medical use and dental use, an artificial bone, an artificial tooth root and the like. Furthermore, hydroxyapatite also has superior adsorption capability to proteins.

In this embodiment, a description will be made on hydroxyapatite, representative, as the synthetic material. However, it goes without saying that the synthetic material is not limited thereto.

The method of producing the powder according to the present embodiment includes a step S1 of obtaining a slurry containing aggregates of hydroxyapatite and a step S2 of obtaining powder of hydroxyapatite by drying the slurry. Furthermore, the method of producing the powder according to the present embodiment may include a sub-step S1-1 of stirring the slurry containing the aggregates of hydroxyapatite. Hereinafter, a description will be made on theses steps one after another.

S1: Step of Obtaining Slurry Containing Aggregates of Hydroxyapatite (First Step)

In this step, a calcium hydroxide dispersion liquid (first liquid) containing calcium hydroxide (first raw material) is mixed with a phosphoric acid aqueous solution (second liquid) containing phosphoric acid (second raw material) to obtain a mixture. Then, calcium hydroxide and phosphoric acid are reacted with stirring the mixture to obtain a slurry containing aggregates of hydroxyapatite.

To be concrete, the phosphoric acid aqueous solution (second liquid) is dropped into the calcium hydroxide dispersion liquid (first liquid) while the first liquid is stirred. By doing so, the calcium hydroxide dispersion liquid and the phosphoric acid aqueous solution are mixed with each other to obtain the mixture. Thereafter, calcium hydroxide is reacted with phosphoric acid in the mixture to obtain the slurry containing the aggregates of hydroxyapatite.

In this embodiment, used is a wet synthesis method that phosphoric acid (second raw material) is used as a aqueous solution. This makes it possible to efficiently and easily synthesize hydroxyapatite (synthetic material) without using an expensive production facility.

Further, by performing this reaction with stirring, it is possible to efficiently perform the reaction between calcium hydroxide and phosphoric acid. In other words, it is possible to improve efficiency of the reaction therebetween.

Furthermore, power for stirring (stirring power) the mixture containing the phosphoric acid aqueous solution and the calcium hydroxide dispersion liquid is not particularly limited to a specific power, but preferably in the range of about 0.75 to 2.0 W and more preferably in the range of about 0.925 to 1.85 W per 1 liter of the mixture (slurry). By setting the stirring power to a value within the above range, it is possible to further improve the efficiency of the reaction between calcium hydroxide and phosphoric acid.

A content of calcium hydroxide in the calcium hydroxide dispersion liquid is preferably in the range of about 5 to 15 wt % and more preferably in the range of about to 12 Wt %. A content of phosphoric acid in the phosphoric acid aqueous solution is preferably in the range of about 10 to 25 wt % and more preferably in the range of about 15 to 20 Wt %. By setting the content of each of calcium hydroxide and phosphoric acid to a value within the above range, it is possible to efficiently react calcium hydroxide and phosphoric acid. Consequently, it is possible to reliably synthesize hydroxyapatite. This is because an opportunity of contacting between calcium hydroxide and phosphoric acid increases when the phosphoric acid aqueous solution is dropped into the calcium hydroxide dispersion liquid while stirring it.

A rate of dropping the phosphoric acid aqueous solution into the calcium hydroxide dispersion liquid is preferably in the range of about 1 to 40 L/hr and more preferably in the range of about 3 to 30 L/hr. By mixing (adding) the phosphoric acid aqueous solution with (to) the calcium hydroxide dispersion liquid at such a dropping rate, it is possible to react calcium hydroxide with phosphoric acid under milder conditions.

In this case, the phosphoric acid aqueous solution is preferably dropped (added) into (to) the calcium hydroxide dispersion liquid for a length of time from about 5 to 32 hours, and more preferably for a length of time from about 6 to 30 hours. By dropping the phosphoric acid aqueous solution into the calcium hydroxide dispersion liquid in such a period of time to react calcium hydroxide with phosphoric acid, it is possible to sufficiently synthesize hydroxyapatite. It is to be noted that even if the time for dropping the phosphoric acid aqueous solution into the calcium hydroxide dispersion liquid is prolonged to exceed the above upper limit value, it cannot be expected that the reaction between calcium hydroxide and phosphoric acid will further proceed.

When the reaction between calcium hydroxide and phosphoric acid gradually proceeds, fine particles of hydroxyapatite (synthetic material) (hereinafter, simply referred to as “fine particles”) are produced in the slurry. A chemical structure of such fine particles includes positively-charged parts and negatively-charged parts. Therefore, Van der Waals' forces (intermolecular force) are made between the positively-charged parts in the chemical structure of one fine particle of the fine particles and the negatively-charged parts in the chemical structure of the other fine particle of the fine particles. By this Van der Waals' forces, the one fine particle and the other fine particle adhere to each other to obtain a pre-aggregate. Then, in the surly, pre-aggregates are agglutinated to obtain aggregates of hydroxyapatite (synthetic material) (hereinafter, simply referred to as “aggregates”). The aggregates make a viscosity of the slurry increase gradually.

When the reaction between calcium hydroxide and phosphoric acid further proceeds, a ratio between the positively-charged parts and the negatively-charged parts of the fine particles contained in the slurry tends to approach each other. At this time, in the slurry, occurs a phenomenon that repulsive force occurring among the fine particles is reduced and the aggregation among fine particles further is proceeded. As a result, aggregates having more large grain size are formed.

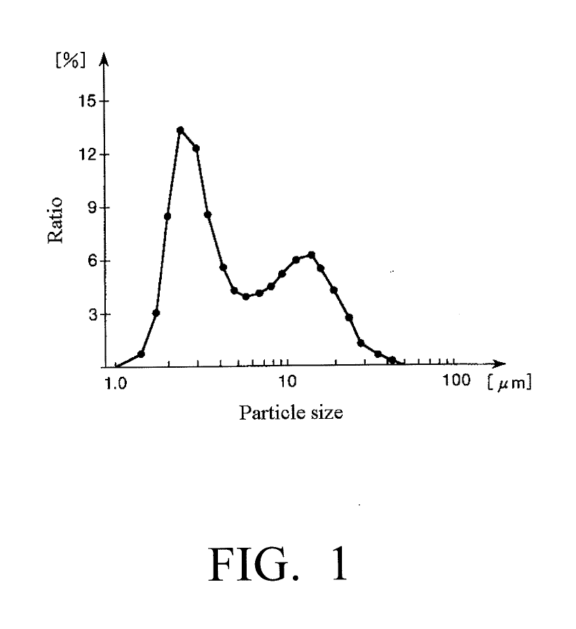

By studying of the present inventors, it has been found that grain sizes of such aggregates are distributed as shown in FIG. 1. When a ratio distribution curve of the grain size distribution of the aggregates is obtained according to sizes of the aggregates depending on a relation between attractive force and repulsive force which occur among the aggregates, the ratio distribution curve has two peaks which include many aggregates as shown in FIG. 1. In this regard, the two peaks include one peak in which a grain size is small and the other peak in which a grain size is large. Hereinafter, in this specification, the aggregates included in one peak of the ratio distribution curve shown in FIG. 1 mean “first aggregates” and the aggregates included in the other peak of the ratio distribution curve shown in FIG. 1 mean “second aggregates”.

After the synthesis of hydroxyapatite in the slurry (mixture) is completed, the slurry containing such first and second aggregates is stirred as shown in the next sub-step [S1-1]. By appropriate setting the conditions of stirring the slurry, it is possible to adjust the grain sizes of the first and second aggregates and an abundance ratio between the first and second aggregates. Furthermore, by drying the slurry containing aggregates that the abundance ratio of the first aggregates is larger than that of the second aggregates in the step [S2], it is possible to obtain hydroxyapatite powder having high particle strength.

In the present invention, the aggregates contain the first and second aggregates as described above, which are represented as the two peaks in FIG. 1. Therefore, it is considered that the following advantage is obtained in the present invention. Since the grain size of the first aggregates is smaller than that of the second aggregates, the first aggregates would enter gaps between the second aggregates. Therefore, it is considered that it is possible to obtain hydroxyapatite powder having high density and high particle strength after the drying step of the slurry. This advantage tends to be reliably obtained by improving a ratio of the first aggregates with respect to the second aggregates.

In contrast, in the present step [S1], a feature resides in that strength of particles of hydroxyapatite powder obtained in the step [S2] is adjusted by setting an initial temperature at which the calcium hydroxide dispersion liquid is mixed with the phosphoric acid aqueous solution.

In the setting of the initial temperature at which the calcium hydroxide dispersion liquid is mixed with the phosphoric acid aqueous solution, the inventors have found that the abundance ratio between the first and second aggregates is not changed. In addition to that, the inventors have also found that a bulk density of dried powder obtained by drying the aggregates contained in the slurry is changed in the next step [S2]. In view of the above, it is supposed that another factor which is different from a factor of the abundance ratio between the first and second aggregates contributes to the adjustment of the particle strength by setting the initial temperature.

By setting the initial temperature at which the calcium hydroxide dispersion liquid is mixed with the phosphoric acid aqueous solution, it is possible to obtain dried powder having an uniform bulk density. Therefore, it is possible to obtain dried powder having uniform particle strength.

In the case where the phosphoric acid aqueous solution (second liquid) is dropped into the calcium hydroxide dispersion liquid (first liquid) with stirring the calcium hydroxide dispersion liquid to react calcium hydroxide with phosphoric acid, the setting of the initial temperature at which the calcium hydroxide dispersion liquid is mixed with the phosphoric acid aqueous solution is carried out by setting an initial temperature of the calcium hydroxide dispersion liquid.

Further, in the case where the bulk density of the dried powder obtained in the next step [S2] is improved so that the strength of the particles of the dried powder is improved, the initial temperature of the calcium hydroxide dispersion liquid is set preferably in the range of about 0 to 20° C. and more preferably in the range of about 5 to 10° C. By setting the initial temperature of the calcium hydroxide dispersion liquid to a value within the above range, it is possible to reliably improve the bulk density of the dried powder.

It is to be noted that this initial temperature is controlled by using devices such as a heating-cooling jacket and a heating-cooling coil. Such devices are set to a tank to obtain the slurry including hydroxyapatite.

Furthermore, when the phosphoric acid aqueous solution is dropped into the calcium hydroxide dispersion liquid, an ambient temperature is not particularly limited to a specific value, but preferably normal temperature (about 25° C.).

Under such conditions, if the phosphoric acid aqueous solution is dropped into the calcium hydroxide dispersion liquid to obtain the mixture, a temperature of the mixture is gradually increased from the initial temperature of the calcium hydroxide dispersion liquid. This is because a reaction between calcium hydroxide and phosphoric acid contained in the mixture is an exothermic reaction. By synthesizing the fine particles of hydroxyapatite in the mixture under the conditions, it is possible to obtain compact fine particles. Therefore, the bulk density of the dried particles obtained in the next step [S2] becomes particularly high.

Since the ambient temperature is the normal temperature, if the temperature of the mixture is higher than 25° C., a heat of the mixture is diffused from the mixture to the atmosphere of the reaction. Therefore, in a state that a slope that the temperature of the mixture is gradually increased with time becomes low, it is possible to obtain a slurry containing the aggregates of hydroxyapatite. At that time, a temperature of the slurry is preferably in the range of 30 to 50° C. and more preferably in the range of 30 to 40° C. By obtaining the slurry within such a temperature range, it is possible to conspicuously exhibit the effects described above.

S1-1: Step of Stirring Slurry

In this step, the slurry obtained in the step [S1] is stirred. In other words, the stirring of the slurry obtained in the step [S1] is maintained.

Stirring the thus obtained slurry makes it possible to reduce the particle sizes of the first and second aggregates contained in the slurry as described in the step [S1]. In addition to that, stirring the thus obtained slurry also makes it possible to increase the abundance ratio of the first aggregates of the first and second aggregates. Therefore, it is possible obtained hydroxyapatite powder having high particle strength in the step [S2] described later. This means that it is possible to adjust the particle strength of the hydroxyapatite powder by keeping on stirring the obtained slurry.

Power for stirring (stirring power) the slurry is not limited to a specific value, but preferably in the range of about 0.75 to 2.0 W and more preferably in the range of about 0.925 to 1.85 W per 1 liter of the slurry. By setting the stirring power to a value within the above range, it is possible to reliably reduce the particle sizes of the first and second aggregates contained in the slurry and increase the abundance ratio of the first aggregates of the abundance ratio each of the first and second aggregates.

In this case, a time of stirring the slurry is preferably in the range of about 3 to 10 days and more preferably in the range of about 5 to 7 days. This makes it possible to reliably reduce the particle sizes of the first and second aggregates contained in the slurry and increase the abundance ratio of the first aggregates of the abundance ratio each of the first and second aggregates.

S2: Step of Obtaining Hydroxyapatite Powder by Drying Slurry (Second Step)

In the second step, hydroxyapatite is granulated by drying the slurry obtained in the step [S1] or the slurry having performed the step [S1-1], so that powder (dried powder) constituted of hydroxyapatite is obtained as a main component thereof.

In the present invention, it becomes it possible for the hydroxyapatite powder obtained in the present step [S2] to reliably exhibit superior particle strength due to the mechanism described above. This is because in each the step [S1] and the step [S1-1], the initial temperature for mixing the calcium hydroxide dispersion liquid with the phosphoric acid aqueous solution is reliably set and the conditions of stirring the obtained slurry is further set appropriately.

In this regard, a method of drying the slurry is not particularly limited to a specific method, but a spray drying method is preferably used. Accordingly to such a method, it is possible to reliably obtain powder having a predetermined particle size for a short period of time.

A drying temperature of the slurry is preferably in the range of about 75 to 250° C. and more preferably in the range of about 95 to 220° C. By setting the drying temperature to a value within the above range, it is possible to obtain powder having excellent particle strength (mechanical strength).

A particle size (grain size) of the particles of the powder to be produced by the method according to the present invention is not particularly limited to a specific size, but preferably in the range of about 3 to 300 μm and more preferably in the range of about 10 to 120 μm.

The method of producing the powder according to the present embodiment is suitable to produce powder containing particles having an intended particle size in the range of about 10 to 80 μm (in particular, about 15 to 43 μm).

In this regard, it is to be noted that such powder (dried powder) can be sintered to obtain sintered powder. This makes it possible to improve particle strength of the powder (sintered powder).

In this case, a sintering temperature of the powder is preferably in the range of about 200 to 800° C. and more preferably in the range of about 400 to 700° C. By completing the steps as described above, it is possible to produce hydroxyapatite powder (synthetic material).

The level of the particle strength of the obtained powder can be determined by, for example, the following method.

More specifically, the particles of the sintered powder obtained by sintering the hydroxyapatite dried powder is classified so that an average particle size of the particles of the sintered powder falls within 40±5 μm, and then compressive particle strength of the classified particles is measured to determine the level of the particle strength of the sintered powder.

The compressive particle strength measured in this way is preferably as large as possible. More specifically, the compressive particle strength is preferably 1.0 MPa or more, more preferably 2.0 MPa or more, even more preferably 4.5 MPa or more and most preferably 5.0 MPa or more. This makes it possible to make a judgment that the sintered powder having such compressive particle strength has high particle strength.

The hydroxyapatite powder (dried powder) produced by the method of producing the powder as described above or the sintered powder obtained by sintering the thus obtained hydroxypatite powder can be used as an adsorbent (stationary phase) of an adsorption apparatus used in a chromatography.

If a liquid containing a plurality of proteins is applied to such an adsorption apparatus and the liquid go thorough the stationary phase including the adsorbent of the adsorption apparatus, the plurality of proteins are adsorbed by the adsorbent, namely, the sintered powder. Thereafter, in such a state, an eluate (buffer) is supplied to the stationary phase including the adsorbent of the adsorption apparatus, and then the plurality of proteins are discharged to different fractions due to a difference of adsorption between each protein and the sintered powder (adsorbent), respectively. This makes it possible to separate the plurality of proteins to the different fractions containing the discharged eluate, respectively.

By using the sintered powder as the adsorbent of the adsorption apparatus used in the chromatography, it is possible to expand the range of choices of conditions for separation or adsorption of an object to be tested (e.g., protein) and thereby to apply such an adsorption apparatus used in the chromatography to a wider range of areas (fields).

Further, such a dried powder is molded in a predetermined shape to obtain a green body, and then the green body is sintered to obtain a sintered body. The thus obtained sintered body can be reliably used as artificial bone such as a vertebral spacer, auditory ossicle and the like, or artificial tooth root.

Although the method of producing the powder, the powder and the adsorption apparatus according to the present invention have been described above with reference to their preferred embodiments, the present invention is not limited to these embodiments.

For example, the method of producing the powder according to the present invention may further include a pre-step before the step [S1], an intermediate step between the step [S1] and the sub-step [S1-1] or between the sub-step [S1-1] and the step [S2], and a post-step after the step [S2] for any purpose.

Further, in this embodiment, the purpose (purpose of the present invention) for setting the initial temperature of mixing the calcium hydroxide dispersion liquid (first liquid) with the phosphoric acid aqueous solution (second liquid) and the conditions of stirring the obtained slurry has been described as a purpose for improving the particle strength of the obtained powder. However, the purpose of the present invention is not limited thereto.

For example, it is possible to obtain powder having predetermined particle strength by appropriately adjust the initial temperature of mixing the calcium hydroxide dispersion liquid (first liquid) with the phosphoric acid aqueous solution (second liquid) and the conditions of stirring the obtained slurry. More specifically, in the case where the synthetic material is hydroxyapatite, it is possible to obtain powder having relatively low particle strength by setting the initial temperature within the range of about 30 to 40° C. or by setting the initial temperature to high and the time of stirring the slurry to short.

### EXAMPLES

Next, the present invention will be described with reference to actual examples.

1. Production of Hydroxyapatite

### Example 1

First, calcium hydroxide of 5000 g was dispersed in pure water of 40 L to obtain a calcium hydroxide dispersion liquid, and then an phosphoric acid aqueous solution (phosphoric acid concentration is 19.8 wt %) of 20 L was dropped into the calcium hydroxide dispersion liquid at a speed of 3 L/hr while the calcium hydroxide dispersion liquid was stirred in a tank. As a result, a slurry of 70 L containing hydroxyapatite of 10 wt % was obtained.

In this regard, it is to be noted that an initial temperature of the calcium hydroxide dispersion liquid before the phosphoric acid aqueous solution was dropped into the calcium hydroxide dispersion liquid, that is a reaction initiation, was set at 10° C. Further, an ambient temperature during the dropping was set at normal temperature (25° C.)

Furthermore, a stirring power of the mixture in which the phosphoric acid aqueous solution was dropped into the calcium hydroxide dispersion liquid was set 1.7 W with respect to 1 L of the mixture (slurry).

A temperature and pH of the mixture (slurry) during the dropping of the phosphoric acid aqueous solution were measured every 10 minutes. The thus obtained slurry of 500 mL was extracted.

Next, the thus obtained slurry (500 mL) was stirred for 7 days at the stirring power of 1.7 W with respect to 1 L of the slurry.

Then, the slurry in which the stirring was completed was spray-dried at 210° C. using a spray drier (manufactured by MATSUBO Corporation under the trade name of “MAD-6737R”) to thereby granulate hydroxyapatite contained in the slurry. In this way, dried powder of particulate dried particles was produced. Thereafter, a part of the thus obtained dried particles (hydroxyapatite powder) was classified to obtain particles having a median particle size of about 40 μm.

In this regard, it is to be noted that the thus obtained dried powder was found to be hydroxyapatite by powder X-ray diffractometry.

### Example 2

Dried powder (hydroxyapatite dried powder) was produced in the same manner as in the Example 1, except that the stirring of the slurry after the slurry was obtained was omitted.

### Example 3

Dried powder (hydroxyapatite dried powder) was produced in the same manner as in the Example 2, except that the initial temperature of the calcium hydroxide dispersion liquid before the reaction initiation was set at 30° C.

### Example 4

Dried powder (hydroxyapatite dried powder) was produced in the same manner as in the Example 2 except that the initial temperature of the calcium hydroxide dispersion liquid before the reaction initiation was set at 40° C.

2. Evaluation

2-1 Evaluation of Temperature and pH of Slurry

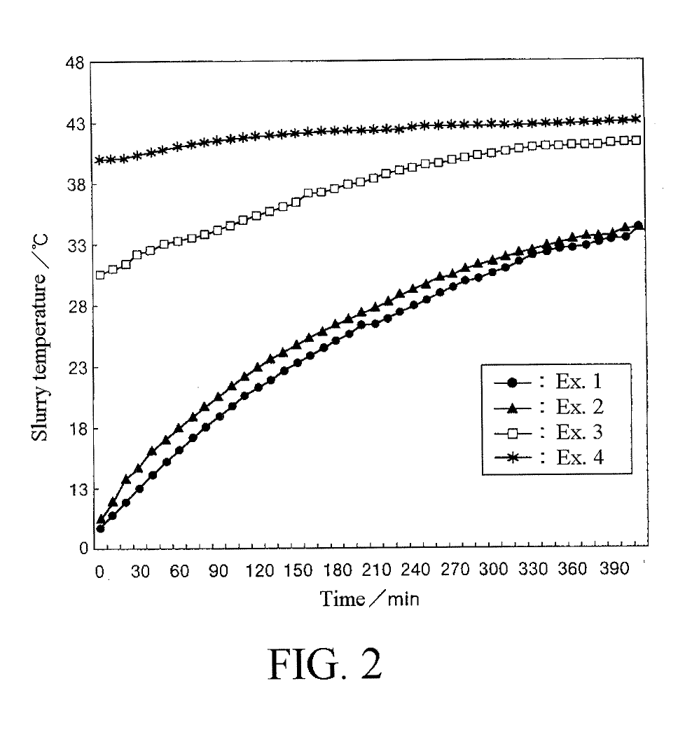

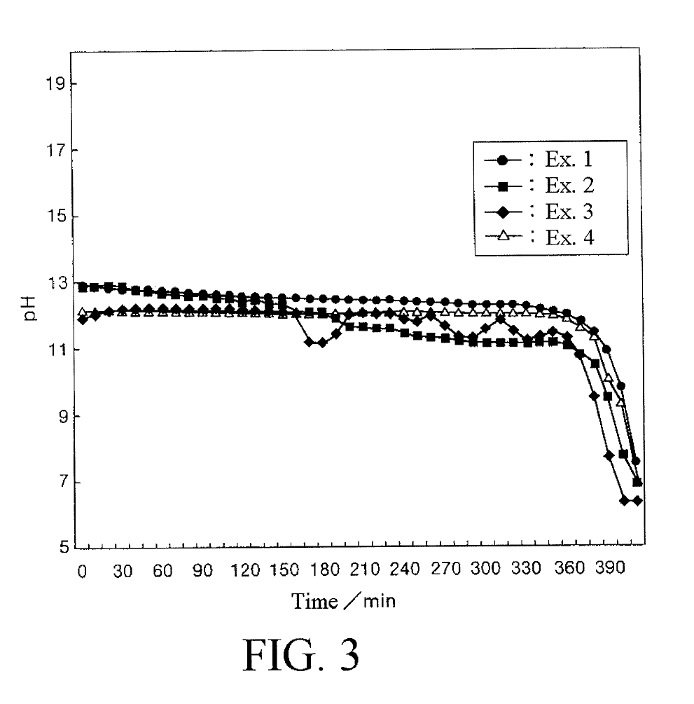

In each of the Examples 1 to 4, the temperature and pH of the mixture (slurry) measured in obtaining the slurry containing the aggregates of hydroxyapatite were measured to obtain results. The results are shown in FIGS. 2 and 3.

As shown in FIG. 2, the temperature of the slurry obtained in each of the Examples 1 to 4 was gradually increased from the initial temperature of the slurry. In this regard, it is to be noted that both exothermic heat by reacting calcium oxide with phosphoric acid and radiation from the mixture to the atmosphere reached substantially a stationary state in the Example 4. The gradually increased width from the initial temperature to the final temperature was small as compared with those of the Examples 2 and 3.

Further, as shown in FIG. 3, the pH of the slurry obtained in each of the Examples 1 to 4 was hardly changed among the results of the Examples 1 to 4. From these results, it was found that the pH of the slurry was not changed by changing the initial temperature of the calcium oxide dispersion liquid before the reaction initiation and when hydroxyapatite was obtained.

2-2 Evaluation of Grain Size Distribution of Hydroxyapatite Aggregates

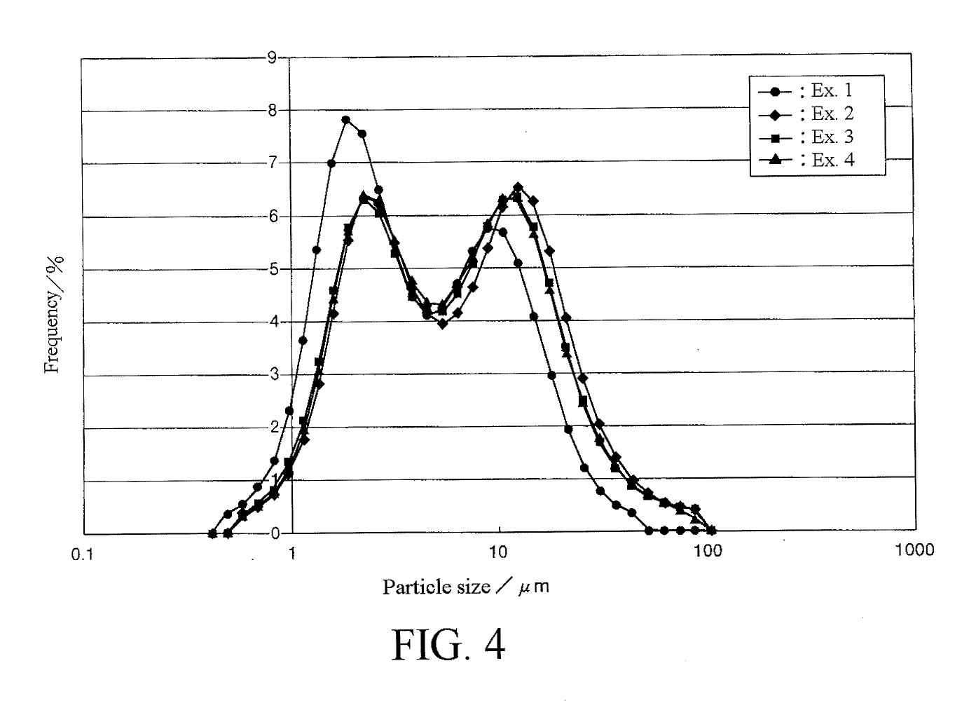

In each of the Examples 1 to 4, the slurry containing the aggregates of hydroxyapatite was subjected to an apparatus of measuring grain size distributions (manufactured by Microtrac Inc. under the trade name of “MT3300”) to obtain a grain size distribution of the aggregates of hydroxyapatite contained in the slurry. The results are shown in FIG. 4.

As shown in FIG. 4, the grain size distribution of the aggregates of hydroxyapatite obtained in each of the Examples 2 to 4 was hardly changed among the results of the Examples 2 to 4. From these results, it was found that the grain size distribution of the aggregates of hydroxyapatite was not changed by changing the initial temperature of the calcium oxide dispersion liquid before the reaction initiation and when hydroxyapatite was obtained.

In contrast, in the grain size distribution of the aggregates of hydroxyapatite obtained in the Example 1 as compared with those obtained in the Examples 2 to 4, it was found that the particle sizes of both the first and second aggregates were small and the abundance ratio of the first aggregates was increased as compared with that of the second aggregates.

2-3 Evaluation of Particle Strength and Bulk Density of Hydroxyapatite Powder

In the dried powder (hydroxyapatite powder) obtained in each of the Examples 1 to 4, the bulk density thereof was measured by using a multitester (manufactured by SEISHIN ENTERPRISE CO., LTD. under the trade name of “MT-1001”).

Each of the dried particles obtained in the Examples 1 to 4 was subjected to a compression testing machine (manufactured by Shimadzu Corporation under the trade name of “MCT-W200-J”) to obtain compression particle strength thereof.

Furthermore, each of the dried particles obtained in the Examples 1 to 4 was sintered at 700° C. for 4 hours under an atmosphere to obtain sintered powder (sintered hydroxyapatite). Then, the compression particle strength of the thus obtained sintered powder was also measured by using the compression testing machine. In this regard, it is to be noted that a value of the compression particle strength is an average value which is calculated by using values of the compression particle strengths of ten particles. The results are shown in Table 1.

TABLE 1
Table 1

| | Initial | Stirring of | Bulk density of | Compression particle | Compression particle |
|---|---|---|---|---|---|
| | temperature | slurry | dried powder | strength of dried powder | strength of sintered powder |
| | [° C.] | [day] | [g/mL] | [MPa] | [MPa] |
| Ex. 1 | 10 | 7 | 0.63 | 2.12 | 5.42 |
| Ex. 2 | 10 | — | 0.57 | 1.33 | 2.71 |
| Ex. 3 | 30 | — | 0.54 | 1.16 | 1.75 |
| Ex. 4 | 40 | — | 0.53 | 1.14 | 1.41 |

As seen from Table 1, in the dried powder obtained in each of the Examples 2 to 4, the lower the initial temperature of calcium hydroxide dispersion liquid was set, the higher the bulk density of the dried powder tended to become. In this connection, it was found the compression particle strengths of the dried powder and the sintered powder became high. In other words, it was found that the compression particle strengths of the dried powder and the sintered powder were improved in connection with the initial temperature by setting the initial temperature of the calcium hydroxide dispersion liquid to low.

Further, in the dried powder obtained in the Example 1, it was found that the particle sizes of both the first and second aggregates were further small and the abundance ratio of the first aggregates was further increased as compared with the dried powder obtained in each of the Examples 2 to 4. In this connection, it was found the compression particle strengths of the dried powder and the sintered powder became high. In other words, it was found that the compression particle strengths of the dried powder and the sintered powder were further improved by stirring the slurry in addition to setting the initial temperature of the calcium hydroxide dispersion liquid to low.

In view of the above, by appropriately setting the initial temperature of the calcium hydroxide dispersion liquid and the stirring conditions of the obtained slurry, it was found that it was possible to produce dried powder and sintered powder having a predetermined compression particle strength.

In particular, the dried powder in the Example 2 was sintered by setting the initial temperature of the calcium hydroxide dispersion liquid to 10° C. to obtain sintered powder. The compression particle strength of the sintered powder showed 2.5 MPa or more, so that it was found that such sintered powder had superior particle strength. Furthermore, the dried powder in the Example 1 was sintered by setting the initial temperature of the calcium hydroxide dispersion liquid to 10° C. and stirring the slurry to obtain sintered powder. The compression particle strength of the sintered powder showed 5.0 MPa or more, so that it was found that such sintered powder had superior particle strength.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

Further, it is also to be understood that the present disclosure relates to subject matters contained in Japanese Patent Applications No. 2009-133531 (filed on Jun. 2, 2009) and No. 2009-133532 (filed on Jun. 2, 2009) which are expressly incorporated herein by reference in their entireties.

1. A method of producing powder by using a first liquid and a second liquid to be mixed with the first liquid, the first liquid containing a first raw material and the second liquid containing a second raw material, and the method comprising:
mixing the first liquid and the second liquid to obtain a mixture;
stirring the mixture for reacting the first raw material and the second raw material to thereby obtain a synthetic material and a slurry containing aggregates of the synthetic material; and
drying the slurry to obtain powder of the synthetic material,
wherein in the mixing the first liquid and the second liquid particle strength of the powder is adjusted by setting an initial temperature of mixing the first liquid with the second liquid.

2. The method as claimed in claim 1 further comprising:
stirring the slurry between the stirring the mixture and the drying the slurry,
wherein in the stirring the slurry the particle strength of the powder is adjusted by setting conditions of stirring the slurry.

3. The method as claimed in claim 1, wherein the second liquid is dropped into the first liquid in the mixing the first liquid and the second liquid to thereby react the first raw material with the second raw material, wherein the initial temperature of mixing the first liquid with second liquid is set by setting an initial temperature of the first liquid.

4. The method as claimed in claim 3, wherein the initial temperature of the first liquid is set in the range of 0 to 20° C.

5. The method as claimed in claim 3, wherein a temperature of the mixture of the first liquid and the second liquid is gradually increased when the second liquid is dropped into the first liquid.

6. The method as claimed in claim 3, wherein when the second liquid is dropped into the first liquid, an ambient temperature is normal temperature.

7. The method as claimed in claim 6, wherein when the slurry is obtained by reacting the first raw material with the second raw material, a temperature of the slurry is in the range of 30 to 50° C.

8. The method as claimed in claim 2, wherein in the stirring the slurry containing the aggregates a stirring power of the slurry is in the range of 0.75 to 2.0 W with respect to 1 L of the slurry.

9. The method as claimed in claim 2, wherein in the stirring the slurry containing the aggregates a time of stirring the slurry is in the range of 3 to 10 days.

10. The method as claimed in claim 1, wherein the synthetic material includes a ceramic material.

11. The method as claimed in claim 1, wherein the synthetic material includes a calcium phosphate-based compound.

12. The method as claimed in claim 1, wherein the first raw material is calcium hydroxide, the second raw material is phosphoric acid and the synthetic material is hyrdoxyapatite.

13. Powder produced by using the method of producing the powder defined in claim 1.

14. Powder constituted of hydroxyapatite as a main component thereof, the powder obtained by drying a slurry containing aggregates of the hydroxyapatite and granulating the aggregates,
wherein the powder is sintered to obtain sintered powder including sintered particles, and then the sintered particles are classified so that an average particle size thereof falls within 4±5 μm, wherein when a compression particle strength of the classified sintered powder is measured, the compression particle strength is 1.0 MPa or more.

15. The powder as claimed in claim 14, wherein the compression particle strength is 2.0 MPa or more.

16. The powder as claimed in claim 14, wherein the compression particle strength is 4.5 MPa or more.

17. An adsorption apparatus provided with the sintered powder obtained by sintering the powder defined in claim 13 as an adsorbent.

18. An adsorption apparatus provided with the sintered powder obtained by sintering the powder defined in claim 14 as an adsorbent.
